(19) United States
(12) Patent Application Publication
(10) Pub. No.: US 2025/0289255 A1
(43) Pub. Date: Sep. 18, 2025

(54) PRINTING DEVICE

(71) Applicant: SEIKO EPSON CORPORATION, Tokyo (JP)

(72) Inventor: Daisuke HIRUMA, MATSUMOTO-SHI (JP)

(21) Appl. No.: 19/078,779

(22) Filed: Mar. 13, 2025

(30) Foreign Application Priority Data
Mar. 15, 2024 (JP) 2024-040898

(51) Int. Cl. B41J 29/393; G01J 3/02; G01J 3/52

(52) U.S. Cl. CPC B41J 29/393; G01J 3/0286; G01J 3/524

(57) ABSTRACT

A printing device 1 includes a printing section configured to print an image onto a medium by ejecting liquid and a colorimetry section 17 configured to measure color of the image, wherein the colorimetry section includes an imaging element 24 configured to capture the image, a case 21 configured to accommodate the imaging element, a shutter 23 attached to the case, and a pressurizing member 27 configured to pressurize inside the case, an exposure opening 22configured to expose the imaging element is formed in the case, the shutter is attached to the case so as to close the exposure opening, the pressurizing member is configured to pressurize inside the case in a state in which the shutter is closed, and the shutter is opened in a state in which inside the case is pressurized by the pressurizing member.

The present application is based on, and claims priority from JP Application Serial Number 2024-040898, filed Mar. 15, 2024, the disclosure of which is hereby incorporated by reference herein in its entirety.

### BACKGROUND

### 1. Technical Field

The present disclosure relates to a printing device.

### 2. Related Art

JP-A-2016-61594 describes an image forming device provided with a colorimetry device for measuring color of a pattern formed on a recording medium. The colorimetry device is configured to include a mist prevention glass and a two dimensional image sensor that captures an image of the pattern through the mist prevention glass. The mist prevention glass protects the two dimensional image sensor. By the mist prevention glass, reduces the risk of ink particles adhering to the two dimensional image sensor.

In such a printing device, the mist prevention glass may be contaminated by the ink particles or light may be dispersed by the mist prevention glass, thereby deteriorating colorimetry accuracy.

### SUMMARY

The printing device solves the above problem includes a printing section configured to print an image onto a medium by ejecting liquid and a colorimetry section configured to measure color of the image, wherein the colorimetry section includes an imaging element configured to capture the image, a case configured to accommodate the imaging element, a shutter attached to the case, and a pressurizing member configured to pressurize inside the case, an exposure opening configured to expose the imaging element is formed in the case, the shutter is attached to the case so as to close the exposure opening, the pressurizing member is configured to pressurize inside the case in a state in which the shutter is closed, and the shutter is opened in a state in which inside the case is pressurized by the pressurizing member.

### BRIEF DESCRIPTION OF THE DRAWINGS

FIG. 1 is a front view showing an embodiment of a printing device.

FIG. 2 is a cross-sectional view of a colorimetry section.

FIG. 3 is a cross-sectional view of a state in which the pressurizing member has changed from the state shown in FIG. 2 to a state of pressurizing inside the case.

FIG. 4 is a cross-sectional view of a state in which a shutter has changed from the state shown in FIG. 3 to a state opened.

FIG. 5 is a cross-sectional view showing a modification of the pressurizing member.

FIG. 6 is a front view showing a modification of the printing device.

### DESCRIPTION OF EMBODIMENTS

One embodiment of a printing device will be described below with reference to the drawings. The printing device is, for example, an inkjet printer that prints images such as characters and photographs by ejecting ink, which is an example of liquid, onto a medium such as paper sheet, film, fabric, or the like.

### Printing Device

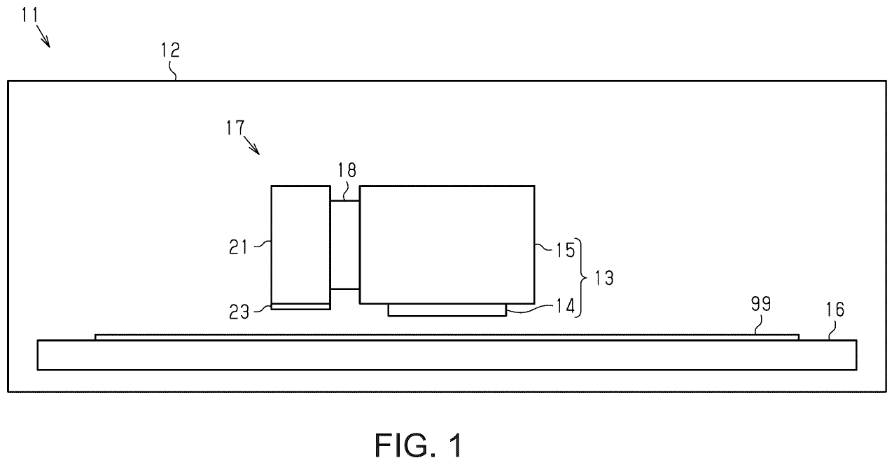

As shown in FIG. 1, a printing device 11 provides a housing 12.

The printing device 11 provides a printing section 13. The printing section 13 is accommodated in the housing 12. The printing section 13 is configured to print on a medium 99. In one example, the printing section 13 prints an image on the medium 99 by ejecting liquid onto the medium 99. The printing section 13 is, for example, a serial head system for scanning with respect to the medium 99. The printing section 13 may be a line head system capable of ejecting liquid all at once across the width of the medium 99. The printing section 13 is not limited to ink and may be configured to print by toner.

The printing section 13 includes a head 14. The head 14 is configured to eject liquid. The printing section 13 prints the image on the medium 99 by the head 14 ejecting liquid onto the medium 99.

The printing section 13 includes a carriage 15. The carriage 15 mounts the head 14. The carriage 15 is configured to scan with respect to the medium 99. By scanning the carriage 15, the head 14 can eject liquid across the width of the medium 99.

The printing device 11 includes a support section 16. The support section 16 is accommodated in the housing 12. The support section 16 is configured to support the medium 99. The support section 16 is positioned so as to face the printing section 13. The support section 16 supports the medium 99 to be printed by the printing section 13.

The printing device 11 provides a colorimetry section 17. The colorimetry section 17 is accommodated in the housing 12. The colorimetry section 17 is attached to, for example, the carriage 15. The colorimetry section 17 is configured to measure color of the image. In one example, the colorimetry section 17 measures color of the image on the medium 99 supported by the support section 16. The colorimetry section 17 will be described later in detail.

The printing device 11 provides a movement mechanism 18. The movement mechanism 18 is accommodated in the housing 12. The movement mechanism 18 is attached to the colorimetry section 17. The movement mechanism 18 is attached to, for example, the carriage 15.

The movement mechanism 18 is configured to move the colorimetry section 17. Specifically, the movement mechanism 18 moves the colorimetry section 17 so as to approach the medium 99 or separate from the medium 99. In one example, the movement mechanism 18 raises and lowers the colorimetry section 17.

The movement mechanism 18 moves the colorimetry section 17 with respect to the carriage 15. When the colorimetry section 17 measures color of the image, the movement mechanism 18 causes the colorimetry section 17 to approach the medium 99. In one example, during measuring color, the movement mechanism 18 lowers the colorimetry section 17. When the movement mechanism 18 causes the colorimetry section 17 to approach the medium 99, the colorimetry section 17 can measure color of the image with high accuracy. The movement mechanism 18 may be configured by a rack and pinion, configured by a ball screw, or configured by a rotating cam.

When the printing section 13 performs printing on the medium 99, the movement mechanism 18 may move the colorimetry section 17 so that the colorimetry section 17 is separated from the medium 99. In one example, during printing, the movement mechanism 18 raises the colorimetry section 17. This reduces the possibility that the colorimetry section 17 interferes with the medium 99 during printing.

### Colorimetry Section

Next, the colorimetry section 17 will be described.

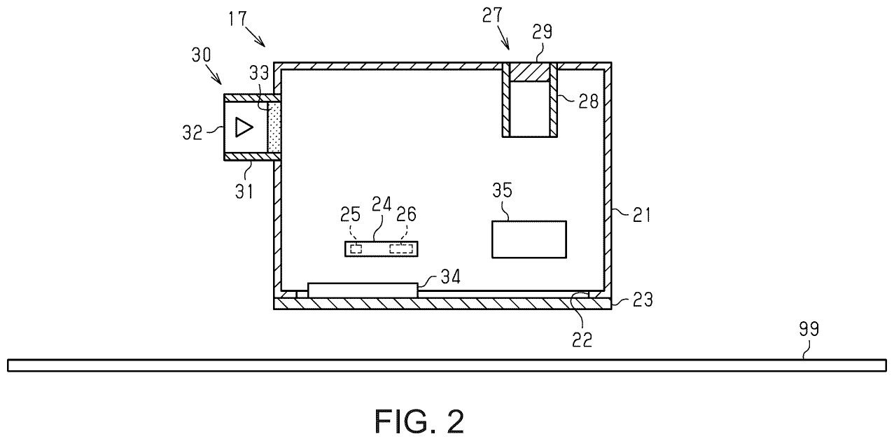

As shown in FIG. 2, the colorimetry section 17 includes a case 21. An exposure opening 22 is opened in the case 21. The exposure opening 22 is an opening that brings inside the case 21 and outside the case 21 into communication with each other. The exposure opening 22 is opened on a surface of the case 21 that faces the medium 99. In one example, the exposure opening 22 is opened on the lower surface of case 21.

The colorimetry section 17 includes a shutter 23. The shutter 23 is attached to the case 21. The shutter 23 is attached to the case 21 so as to close the exposure opening 22. The shutter 23 is configured to open and close with respect to the case 21. Specifically, the shutter 23 displaces to open the exposure opening 22 or close the exposure opening 22. For example, by sliding, the shutter 23 opens and closes with respect to case 21. The shutter 23 is moved by a drive source (not shown). The shutter 23 is normally closed. Accordingly, it is possible to reduce the concern that foreign matter such as mist of liquid by the printing section 13 and dust in the air will enter the case 21.

The colorimetry section 17 includes an imaging element 24. The imaging element 24 is configured to capture the image. The imaging element 24 is accommodated in the case 21. The imaging element 24 is positioned so as to be exposed from the exposure opening 22. Specifically, by opening the shutter 23, the imaging element 24 is exposed through the exposure opening 22. The imaging element 24 captures the image through the exposure opening 22. By capturing the image by the imaging element 24, the colorimetry section 17 measures color of the image.

The imaging element 24 includes a light source 25. The light source 25 irradiates light towards the exposure opening 22. When shutter 23 is opened, the light source 25 irradiates the image with light through the exposure opening 22. The imaging element 24 includes a light receiving sensor 26. The light receiving sensor 26 receives the reflection light of the image by the light source 25. When the shutter 23 is opened, the light receiving sensor 26 receives the reflection light of the image through the exposure opening 22. Accordingly, the colorimetry section 17 measures color of the image. In the colorimetry section 17, since the imaging element 24 directly receives the reflection light of the image through the exposure opening 22 without passing through a transparent plate such as a glass plate or an acrylic plate, the colorimetry section 17 can measure color of the image with high accuracy. On the other hand, there is a possibility that foreign matter enters the case 21 through the exposure opening 22.

The colorimetry section 17 includes a pressurizing member 27. The pressurizing member 27 is configured to pressurize inside the case 21. In one example, the pressurizing member 27 includes a cylinder 28 and a piston 29. The cylinder 28 is attached to the case 21. The cylinder 28 extends so as to bring inside the case 21 and outside the case 21 into communication with each other. The piston 29 is attached to the cylinder 28. The piston 29 is configured to move within the cylinder 28. By moving the piston 29, inside the case 21 is pressurized. For example, by moving the piston 29 toward inside the case 21, inside the case 21 is pressurized. The piston 29 moves within the cylinder 28 by a drive source (not shown). The piston 29 may be moved by the drive source of the shutter 23, or may be moved by the drive source of the movement mechanism 18. The pressurizing member 27 is not limited to the configuration of pressurizing by the piston 29, as long as it can increase the air pressure inside the case 21 compared with the air pressure outside the case 21. The pressurizing member 27 may be configured to increase the amount of gas or configured to expand the gas, other than the configuration in which the gas in the case 21 is compressed by the piston 29 in the space in which the shutter 23 is closed.

The pressurizing member 27 may be configured to depressurize inside the case 21. In one example, by moving piston 29 toward outside the case 21, inside the case 21 is depressurized.

The pressurizing member 27 pressurizes inside the case 21 in a state in which the shutter 23 is closed. In one example, the piston 29 moves so as to toward inside the case 21 in a state in which the shutter 23 is closed. At this time, the pressure inside the case 21 becomes larger than the pressure outside the case 21.

The pressurizing member 27 may depressurize inside the case 21 in a state in which the shutter 23 is closed. In one example, the piston 29 moves so as to toward outside the case 21 in a state in which the shutter 23 is closed. At this time, the pressure inside the case 21 becomes smaller than the pressure outside the case 21.

The colorimetry section 17 may include an intake section 30. The intake section 30 is attached to the case 21. The intake section 30 is configured to take air into the case 21 from outside the case 21. Specifically, the intake section 30 is configured to intake air from outside the case 21 in a state in which foreign matter is unlikely to enter the case 21. If air is taken into the case 21 through the exposure opening 22, foreign matter may adhere to the imaging element 24. By taking air into the case 21 through the intake section 30, the possibility of foreign matter adhering to the imaging element 24 is reduced.

The intake section 30 includes an intake pipe 31. The intake pipe 31 extends from the case 21. The intake pipe 31 brings inside the case 21 and outside the case 21 into communication with each other. Air flows from outside the case 21 into the case 21 through the intake pipe 31. Specifically, as the pressurizing member 27 decompresses inside the case 21, air flows from outside the case 21 into inside the case 21 through the intake pipe 31. For example, the intake pipe 31 is positioned on a surface of the case 21 that does not face the medium 99. This makes it difficult for foreign matter generated from the medium 99 to enter the case 21.

The intake section 30 may include an intake valve 32. The intake valve 32 is positioned in the intake pipe 31. The intake valve 32 is a valve for opening and closing the intake pipe 31. By opening the intake valve 32, air can flow inside and outside the case 21 through the intake pipe 31. In one example, the intake valve 32 is a one way valve. The intake valve 32 is a valve that allows air to flow into the case 21 from outside the case 21 through the intake pipe 31. The intake valve 32 is a valve that restricts air from flowing out from inside the case 21 to outside the case 21 through the intake pipe 31. That is, the intake valve 32 opens the intake pipe 31 with respect to air flowing into the case 21 from outside the case 21. The intake valve 32 closes the intake pipe 31 with respect to air flowing from inside the case 21 to outside the case 21. The possibility of air flowing out from inside the case 21 through the intake pipe 31 is reduced by the intake valve 32. The intake valve 32 may be an on-off valve that opens and closes electromagnetically.

The intake section 30 may include a filter 33. The filter 33 is configured to perform filtration of air. The filter 33 is positioned in the intake pipe 31. This reduces the possibility of foreign matter entering through the intake section 30. The filter 33 is positioned, for example, so as to perform filtration of air after it has passed through the intake valve 32. The filter 33 may be positioned so as to the filtration of air prior to its passage through the intake valve 32.

The colorimetry section 17 may include a calibration plate 34. The calibration plate 34 is a plate for calibrating the imaging element 24. The calibration plate 34 is a so-called reference plate. The calibration plate 34 is, for example, a plate of white. The colorimetry section 17 calibrates the imaging element 24 by causing the light source 25 to irradiate the calibration plate 34 with light and causing the light receiving sensor 26 to receive the reflection light from the calibration plate 34.

The calibration plate 34 is communicates in the case 21. The calibration plate 34 is attached to the shutter 23. When the shutter 23 is closed, the calibration plate 34 is positioned at a position where the image is captured by the imaging element 24. For example, when the shutter 23 is closed, the calibration plate 34 faces the imaging element 24. When the shutter 23 is opened, the calibration plate 34 retreats from the position facing the imaging element 24. In this manner, when the shutter 23 is closed, the colorimetry section 17 can calibrate the imaging element 24. When the shutter 23 is opened, the colorimetry section 17 can measure color of the image.

The colorimetry section 17 includes a control circuit 35. The control circuit 35 is configured to control the various configurations provided by the colorimetry section 17. The control circuit 35 controls the shutter 23, the imaging element 24, the pressurizing member 27, and the like. The control circuit 35 may include a circuit with a processor that has a CPU and a memory. The control circuit 35 may include a hardware circuit such as an ASIC. The control circuit 35 may include a circuit that comprises a combination of a processor and a hardware circuit. The control circuit 35 may be a circuit configured to control the various configurations provided by the printing device 11. In this case, the control circuit 35 may control the printing section 13 in addition to the colorimetry section 17.

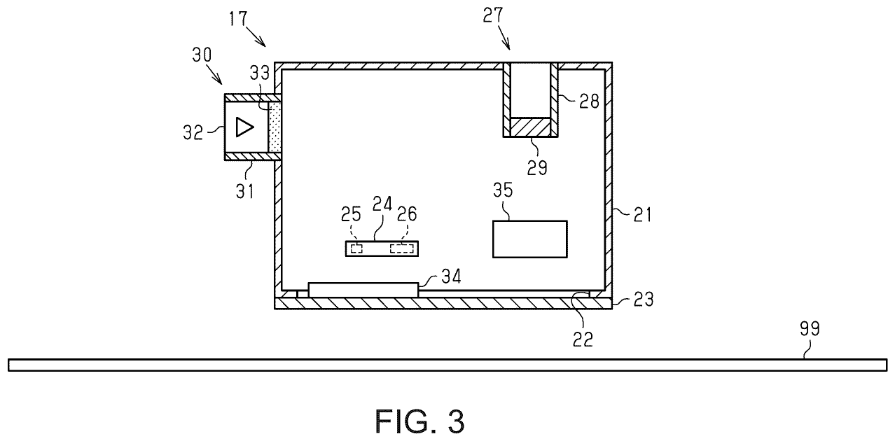

As shown in FIG. 3, the control circuit 35 pressurizes inside the case 21 by the pressurizing member 27 in a state in which the shutter 23 is closed. Specifically, the control circuit 35 pressurizes inside the case 21 by the pressurizing member 27 in a state in which the shutter 23 is closed before measuring color of the image. In one example, the control circuit 35 lowers the piston 29 in a state in which the shutter 23 is closed before measuring color of the image.

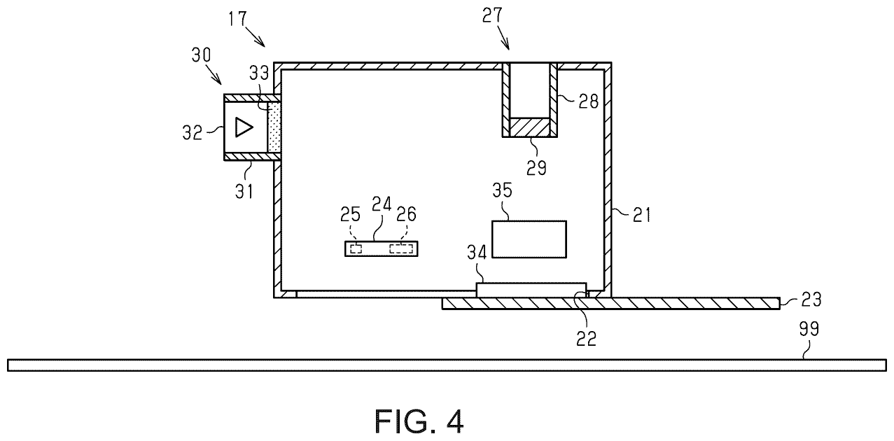

As shown in FIG. 4, when measuring color of the image, the control circuit 35 opens the shutter 23. Specifically, when measuring color of the image is performed, the control circuit 35 opens the shutter 23 in a state in which inside the case 21 is pressurized by the pressurizing member 27. That is, the shutter 23 opens in a state in which inside the case 21 is pressurized by the pressurizing member 27. At this time, air flows out from inside the case 21 to outside the case 21 through the exposure opening 22. Therefore, there is little possibility that foreign matter enters the case 21 from outside the case 21 through the exposure opening 22. Therefore, it is possible to capture the image by the imaging element 24 while reducing the possibility of foreign matter adhering to the imaging element 24.

After completing the measuring color of the image, the control circuit 35 closes the shutter 23. The control circuit 35 decompresses inside the case 21 by the pressurizing member 27 in a state in which the shutter 23 is closed. Specifically, after completing the measuring color of the image, the control circuit 35 depressurizes inside the case 21 by the pressurizing member 27 in a state in which the shutter 23 is closed. Accordingly, air flows into the case 21 through the intake section 30. Therefore, the risk of foreign matter adhering to the imaging element 24 is reduced. The colorimetry section 17 may be controlled by a control section provided in the printing device 11.

### Operation and Effect of the Embodiment

Next, the operation and effects of the above embodiment will be described.

(1) The pressurizing member 27 pressurizes inside the case 21 in a state in which the shutter 23 is closed. The shutter 23 is opened in a state in which inside the case 21 is pressurized by the pressurizing member 27. According to the above configuration, when the shutter 23 is opened in a state in which inside the case 21 is pressurized by the pressurizing member 27, air flows from inside the case 21 to outside the case 21 through the exposure opening 22. Therefore, the possibility that foreign matter enters the case 21 from outside the case 21 through the exposure opening 22 is reduced. This reduces the possibility that foreign matter adheres to the imaging element 24. Since the colorimetry section 17 can measure color of the image directly instead of through the glass, the image can colorimetry on the image with high accuracy.

(2) The pressurizing member 27 includes the cylinder 28 attached to the case 21 and the piston 29 the moves in the cylinder 28. According to the above configuration, inside the case 21 can be pressurized by the movement of the piston 29.

(3) The intake section 30 includes the intake pipe 31 bring inside the case 21 and outside the case 21 into communication with each other and the intake valve 32 configured to open and close the intake pipe 31. According to the above configuration, as compared with the case where air flows into the case 21 through the exposure opening 22, the risk of foreign matter adhering to the imaging element 24 is reduced.

(4) The intake valve 32 is a one way valve configured to allow air to flow from outside the case 21 into the case 21 through the intake pipe 31. According to the above configuration, air does not flow from inside the case 21 to outside the case 21 through the intake section 30. Therefore, when the pressurizing member 27 pressurizes inside the case 21, pressurized air flows out from the exposure opening 22. This makes it difficult for foreign matter to enter the case 21.

(5) The intake section 30 includes the filter 33 configured to perform air filtration. The filter 33 is positioned in the intake pipe 31. According to the above configuration, air filtered by the filter 33 enters the case 21. Therefore, it is difficult for foreign matter to enter the case 21.

(6) The calibration plate 34 is attached to the shutter 23. According to the above configuration, the imaging element 24 is calibrated by the calibration plate 34 and thus the colorimetry accuracy of the colorimetry section 17 is maintained.

### Modifications

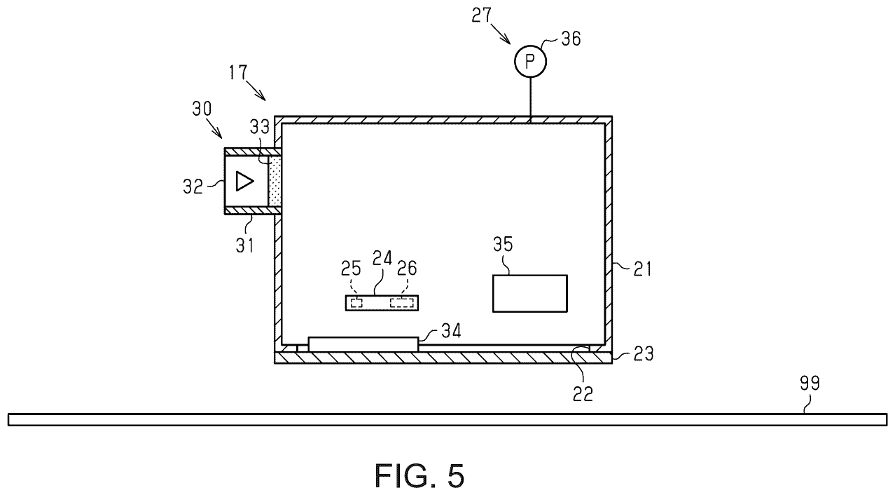

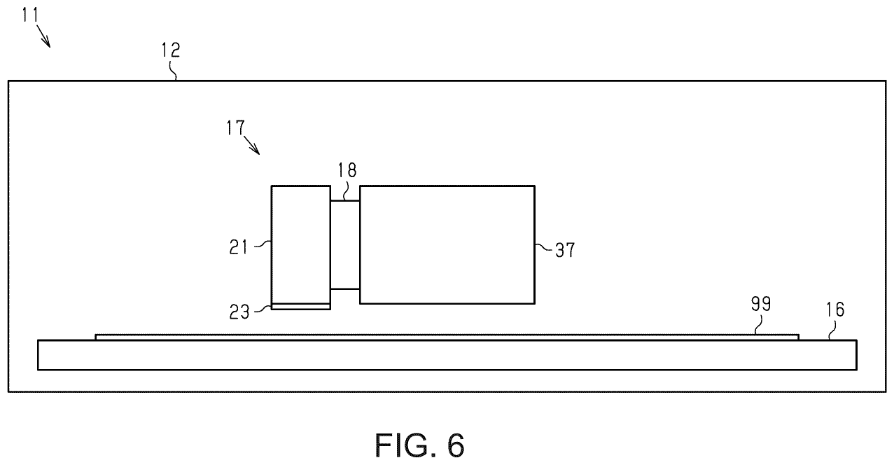

The above described embodiment may be modified as follows. The above described embodiments and the following modifications can be implemented in combination with each other to the extent that they are not technically contradictory.
As shown in FIG. 5, the pressurizing member 27 may include a pump 36. The pump 36 is connected to the case 21. The pump 36 is configured to pressurize inside the case 21. For example, pump 36 pressurizes inside the case 21 by sending air into case 21. The pump 36 may be configured to depressurize inside the case 21. For example, pump 36 depressurizes inside the case 21 by sucking air from inside the case 21. In this modification, since the pressurizing member 27 can continuously pressurize inside the case 21 as compared with the above described embodiment, the colorimetry section 17 may not include the intake section 30. Note that, the pump 36 may always be in a state of sending air into the case 21. Since the pump 36 always sends air into the case 21, it is possible to maintain a state in which foreign matter is difficult to enter the case 21. When the shutter 23 is opened, the pump 36 may send air into the case 21. By sending air into the case 21 when the shutter 23 is opened, it is possible to reduce the possibility that foreign matter enters the case 21 from outside the case 21 through the exposure opening 22.
As shown in FIG. 6, the printing device 11 may provide a movement body 37, which is different from the carriage 15 on which the head 14 is mounted. The movement body 37 is configured to move within the housing 12. The colorimetry section 17 may be attached to the movement body 37. For example, the colorimetry section 17 is attached to the movement body 37 via the movement mechanism 18. In this case, the printing device 11 can cause the colorimetry section 17 to measure color of the image at an arbitrary position on the medium 99 by moving the movement body 37.
The colorimetry section 17 may be attached to the housing 12. For example, the colorimetry section 17 is attached to the housing 12 via the movement mechanism 18. In this case, the colorimetry section 17 moves up and down with respect to the housing 12. In this modification, for example, the user can position the medium 99 directly under the colorimetry section 17 to cause the colorimetry section 17 to measure color of the image.
The printing device 11 may cause the colorimetry section 17 to approach the medium 99 or separate from the medium 99 by raising and lowering the carriage 15. The carriage 15 is generally configured to be able to raise and lower in order to adjust the distance between the head 14 and the medium 99. Therefore, the colorimetry section 17 can be raised and lowered by raising and lowering the carriage 15. In this case, the movement mechanism 18 is a mechanism for raising and lowering the carriage 15.
The intake pipe 31 may be a narrow tube having a small diameter so that flow resistance of air is generated. In this modification, when the pressurizing member 27 decompresses inside the case 21, it is difficult for foreign matter to enter inside the case 21 through the intake pipe 31. When the pressurizing member 27 pressurizes inside the case 21, it is difficult for air to flow out from inside the case 21 through the intake pipe 31.
The liquid ejected by the head 14 is not limited to ink, and may be, for example, a liquid in which particles of a functional material are dispersed or mixed. For example, the head 14 may eject a liquid material containing a material such as an electrode material or a pixel material used for manufacturing a liquid crystal display, an electroluminescence display, or a surface emitting display in a dispersed or dissolved form.

### Technical Ideas

Hereinafter, technical ideas grasped from the above described embodiment and modifications, and operations and effects thereof will be described.

(A) A printing device includes a printing section configured to print an image onto a medium by ejecting liquid and a colorimetry section configured to measure color of the image, wherein the colorimetry section includes an imaging element configured to capture the image, a case configured to accommodate the imaging element, a shutter attached to the case, and a pressurizing member configured to pressurize inside the case, an exposure opening configured to expose the imaging element is formed in the case, the shutter is attached to the case so as to close the exposure opening, the pressurizing member is configured to pressurize inside the case in a state in which the shutter is closed, and the shutter is opened in a state in which inside the case is pressurized by the pressurizing member. According to the above described configuration, when the shutter is opened in a state in which inside the case is pressurized by the pressurizing member, air flows from inside the case to outside the case through the exposure opening. Therefore, the possibility that foreign matter enters the case from outside the case through the exposure opening is reduced. This reduces the possibility that foreign matter adhering to the imaging element. Since the colorimetry section can perform colorimetry on the image directly instead of through the glass, the image can measure color of the image with high accuracy.

(B) In the above printing device may be such that, the pressurizing member includes a cylinder attached to the case and a piston that moves in the cylinder. According to the above configuration, inside the case can be pressurized by the movement of the piston.

(C) In the above printing device may be such that, the colorimetry section includes an intake section configured to take air into the case from outside the case and the intake section includes an intake pipe bringing inside the case and outside the case into communication with each other and an intake valve configured to open and close the intake pipe. According to the above configuration, as compared with the case where air flows into the case through the exposure opening, the risk of foreign matter adhering to the imaging element is reduced.

(D) In the above printing device may be such that, the intake valve is a one way valve configured to allow air to flow from outside the case into the case through the intake pipe. According to the above configuration, air does not flow from inside the case to outside the case through the intake section. Therefore, when the pressurizing member pressurizes inside the case, the pressurized air flows out from the exposure opening. This makes it difficult for foreign matter to enter the case.

(E) In the above printing device may be such that, the intake section includes a filter configured to perform air filtration and the filter is positioned in the intake pipe. According to the above configuration, air filtered by the filter enters the case. Therefore, it is difficult for foreign matter to enter the case.

(F) In the above printing device may be such that, the colorimetry section includes a calibration plate configured to calibrate the imaging element and the calibration plate is attached to the shutter. According to the above configuration, the colorimetry accuracy is maintained by calibrating the imaging element.

What is claimed is:

1. A printing device comprising:
a printing section configured to print an image onto a medium by ejecting liquid and
a colorimetry section configured to measure color of the image, wherein
the colorimetry section includes
an imaging element configured to capture the image,
a case configured to accommodate the imaging element,
a shutter attached to the case, and
a pressurizing member configured to pressurize inside the case,
an exposure opening configured to expose the imaging element is formed in the case,
the shutter is attached to the case so as to close the exposure opening,
the pressurizing member is configured to pressurize inside the case in a state in which the shutter is closed, and
the shutter is opened in a state in which inside the case is pressurized by the pressurizing member.

2. The printing device according to claim 1, wherein
the pressurizing member includes
a cylinder attached to the case and
a piston that moves in the cylinder.

3. The printing device according to claim 1, wherein
the colorimetry section includes an intake section configured to take air into the case from outside the case and
the intake section includes
an intake pipe bringing inside the case and outside the case into communication with each other and
an intake valve configured to open and close the intake pipe.

4. The printing device according to claim 3, wherein
the intake valve is a one way valve configured to allow air to flow from outside the case into the case through the intake pipe.

5. The printing device according to claim 3, wherein
the intake section includes a filter configured to perform air filtration and
the filter is positioned in the intake pipe.

6. The printing device according to claim 1, wherein
the colorimetry section includes a calibration plate configured to calibrate the imaging element and
the calibration plate is attached to the shutter.
